(19) United States
(12) Patent Application Publication
(10) Pub. No.: US 2008/0030136 A1
(43) Pub. Date: Feb. 7, 2008

(54) Plasma display panel

(75) Inventors: Jongwoon Bae, Gumi-si (KR); Gyungrae Kim, Dalseo-gu (KR); Seonghwan Ryu, Gumi-si (KR); Kirack Park, Chilgok-gun (KR)

Correspondence Address: KED & ASSOCIATES, LLP, P.O. Box 221200, Chantilly, VA, 20153-1200, US

(73) Assignee: LG Electronics Inc.

(21) Appl. No.: 11/607,988

(22) Filed: Dec. 4, 2006

(30) Foreign Application Priority Data
Aug. 7, 2006 (KR) 10-2006-0074442
Aug. 10, 2006 (KR) 10-2006-0075913

(51) Int. Cl. H01J 17/49

(52) U.S. Cl. 313/584; 313/585

(57) ABSTRACT

A plasma display panel is disclosed. The plasma display panel includes a front substrate, a rear substrate, and a barrier rib. On the front substrate, a first electrode and a second electrode are formed in parallel to each other. On the rear substrate, a third electrode is formed to intersect the first electrode and the second electrode. The barrier rib is formed between the front and the rear substrate and partitions a discharge cell. At least one of the first electrode or the second electrode is formed in the form of a single layer. An exhaust unit is omitted in the rear substrate.

This Nonprovisional application claims priority under 35 U.S.C. §119(a) on Patent Application No. 10-2006-0075913 filed in Korea on Aug. 10, 2006 the entire contents of which are hereby incorporated by reference.

### BACKGROUND

1. Field

This document relates to a plasma display panel.

2. Description of the Background Art

A plasma display panel includes a phosphor layer inside discharge cells partitioned by barrier ribs and a plurality of electrodes.

A driving signal is supplied to the discharge cells through the electrodes, thereby generating a discharge inside the discharge cells.

When the driving signal generates the discharge inside the discharge cells, a discharge gas filled in the discharge cells generates vacuum ultraviolet rays, which thereby cause phosphors formed inside the discharge cells to emit light, thus displaying an image on the screen of the plasma display panel.

### SUMMARY OF THE INVENTION

In one aspect, a plasma display panel comprises a front substrate on which a first electrode and a second electrode are formed in parallel to each other, a rear substrate on which a third electrode is formed to intersect the first electrode and the second electrode, and a barrier rib formed between the front and rear substrates and partitioning a discharge cell, wherein at least one of the first electrode or the second electrode is formed in the form of a single layer, and an exhaust unit is omitted in the rear substrate.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIGS. 1a to 1d illustrate an example of a structure of a plasma display panel according to one embodiment;

FIG. 2 illustrates an example of a method of manufacturing the plasma display panel according to one embodiment in which an exhaust hole is omitted;

FIG. 3 illustrates a reason why a first electrode and a second electrode have a single layer structure in the structure of the plasma display panel in which an exhaust unit is omitted;

FIG. 4 illustrates an example of a structure in which a black layer is formed between first and second electrodes and a front substrate;

FIG. 5 illustrates a first example associated with a first electrode and a second electrode in the plasma display panel according to one embodiment;

FIGS. 6a to 6c illustrate a second example associated with a first electrode and a second electrode in the plasma display panel according to one embodiment;

FIG. 7 illustrates a third example associated with a first electrode and a second electrode in the plasma display panel according to one embodiment;

FIG. 8 illustrates a fourth example associated with a first electrode and a second electrode in the plasma display panel according to one embodiment;

FIG. 9 illustrates a fifth example associated with a first electrode and a second electrode in the plasma display panel according to one embodiment;

FIG. 10 illustrates a sixth example associated with a first electrode and a second electrode in the plasma display panel according to one embodiment;

FIGS. 11a and 11b illustrate a seventh example associated with a first electrode and a second electrode in the plasma display panel according to one embodiment;

FIG. 12 illustrates an eighth example associated with a first electrode and a second electrode in the plasma display panel according to one embodiment;

FIG. 13 illustrates a ninth example associated with a first electrode and a second electrode in the plasma display panel according to one embodiment;

FIG. 14 illustrates a tenth example associated with a first electrode and a second electrode in the plasma display panel according to one embodiment;

FIGS. 15a and 15b illustrate an eleventh example associated with a first electrode and a second electrode in the plasma display panel according to one embodiment;

FIG. 16 illustrates a frame for achieving a gray level of an image displayed on the plasma display panel according to one embodiment;

FIG. 17 illustrates an example of an operation of the plasma display panel according to one embodiment;

FIGS. 18a and 18b illustrate another form of a rising signal or a second falling signal; and

FIG. 19 illustrates another type of a sustain signal.

### DETAILED DESCRIPTION OF PREFERRED EMBODIMENTS

Reference will now be made in detail embodiments of the invention examples of which are illustrated in the accompanying drawings.

A plasma display panel comprises a front substrate on which a first electrode and a second electrode are formed in parallel to each other, a rear substrate on which a third electrode is formed to intersect the first electrode and the second electrode, and a barrier rib formed between the front and rear substrates and partitioning a discharge cell, wherein at least one of the first electrode or the second electrode is formed in the form of a single layer, and an exhaust unit is omitted in the rear substrate.

A plasma display panel comprises a front substrate on which a first electrode and a second electrode are formed in parallel to each other, a rear substrate on which a third electrode is formed to intersect the first electrode and the second electrode, and a barrier rib formed between the front and rear substrates and partitioning a discharge cell, wherein at least one of the first electrode or the second electrode is formed in the form of a single layer, the rear substrate is a hole-less substrate, and a lead (Pb) content is equal to or less than 1,000 ppm (parts per million).

A plasma display panel comprises a front substrate on which a first electrode and a second electrode are formed in parallel to each other, a rear substrate on which a third electrode is formed to intersect the first electrode and the second electrode, and a barrier rib formed between the front and rear substrates and partitioning a discharge cell, wherein at least one of the first electrode or the second electrode is formed in the form of a single layer, the rear substrate is a hole-less substrate, the discharge cell includes a first discharge cell and a second discharge cell having a different pitch, and a first phosphor layer is formed in the first discharge cell, and a second phosphor layer, that emits light of a color different from a color of light emitted from the first phosphor layer, is formed in the second discharge cell.

Hereinafter, exemplary embodiments will be described in detail with reference to the attached drawings.

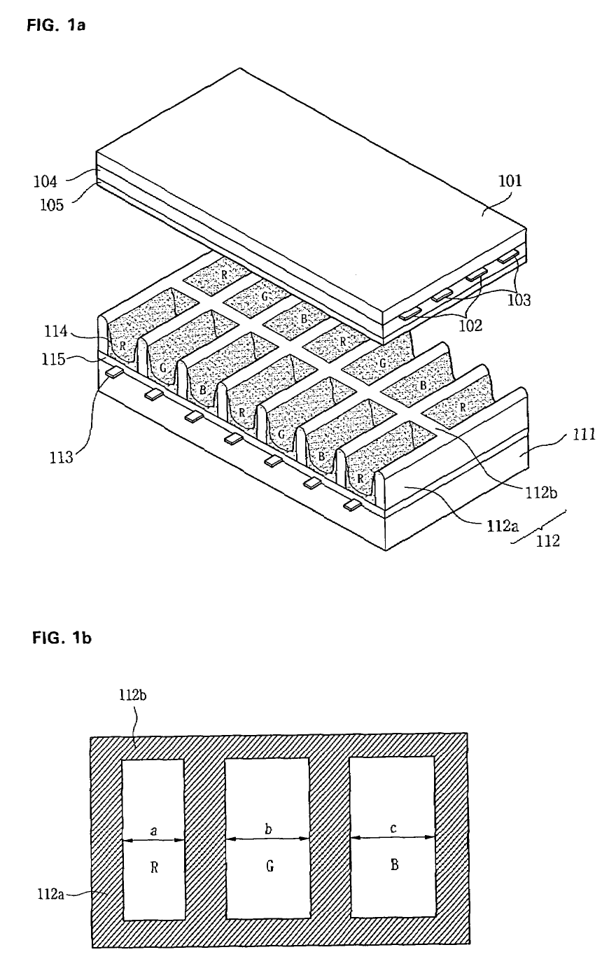

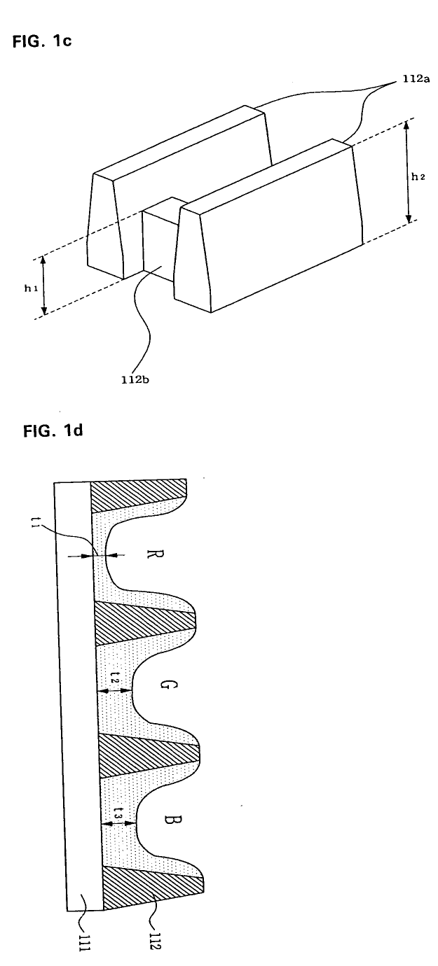

FIGS. 1a to 1d illustrate an example of a structure of a plasma display panel according to one embodiment.

Referring to FIG. 1a, the plasma display panel according to one embodiment includes a front substrate 101 and a rear substrate 111 which are coalesced with each other. On the front substrate 101, a first electrode 102 and a second electrode 103 are formed in parallel to each other. On the rear substrate 111, a third electrode 113 is formed to intersect the first electrode 102 and the second electrode 103.

At least one of the first electrode 102 and the second electrode 103 includes a single layer. For example, the first electrode 102 and the second electrode 103 may a non-transparent electrode (i.e., an ITO (indium-tin-oxide)-less electrode).

A color of at least one of the first electrode 102 and the second electrode 103 may be darker than a color of an upper dielectric layer 104 which will be described later.

An exhaust unit is omitted in the rear substrate 111. The exhaust unit may be omitted in the front substrate 101 and the rear substrate 111. The exhaust unit may be at least one of an exhaust hole, an exhaust tip, or an exhaust pipe.

The first electrode 102 and the second electrode 103 generate a discharge inside discharge spaces (i.e., discharge cells), and maintain the discharges of the discharge cells.

The upper dielectric layer 104 for covering the first electrode 102 and the second electrode 103 is formed on an upper portion of the front substrate 101 on which the first electrode 102 and the second electrode 103 are formed.

The upper dielectric layer 104 limits discharge currents of the first electrode 102 and the second electrode 103, and provides insulation between the first electrode 102 and the second electrode 103.

A protective layer 105 is formed on an upper surface of the upper dielectric layer 104 to facilitate discharge conditions. The protective layer 105 may be formed by deposing a material such as magnesium oxide (MgO) on an upper portion of the upper dielectric layer 104.

A lower dielectric layer 115 for covering the third electrode 113 is formed on an upper portion of the rear substrate 111 on which the third electrode 113 is formed. The lower dielectric layer 115 provides insulation of the third electrode 113.

Barrier ribs 112 of a stripe type, a well type, a delta type, a honeycomb type, and the like, may be formed on an upper portion of the lower dielectric layer 115 to partition discharge spaces (i.e., discharge cells). A red (R) discharge cell, a green (G) discharge cell, and a blue (B) discharge cell, and the like, are formed between the front substrate 101 and the rear substrate 111.

In addition to the red (R), green (G), and blue (B) discharge cells, a white (W) discharge cell or a yellow (Y) discharge cell may be further formed between the front substrate 101 and the rear substrate 111.

Pitches of the red (R), green (G), and blue (B) discharge cells may be substantially equal to one another. However, the pitches of the red (R), green (G), and blue (B) discharge cells, as illustrated in FIG. 1b, may be different from one another to control a white balance in the red (R), green (G), and blue (B) discharge cells.

In this case, the pitches of all of the red (R), green (G), and blue (B) discharge cells may be different from one another, or alternatively, the pitch of at least one of the red (R), green (G), and blue (B) discharge cells may be different from the pitches of the other discharge cells. For instance, as illustrated in FIG. 1b, a pitch (a) of the red (R) discharge cell is the smallest, and pitches (b and c) of the green (G) and blue (B) discharge cells is more than the pitch (a) of the red (R) discharge cell.

The pitch (b) of the green (G) discharge cell may be substantially equal to or different from the pitch (c) of the blue (B) discharge cell.

The plasma display panel according one embodiment may have various forms of barrier rib structures as well as a structure of the barrier rib 112 illustrated in FIG. 1a. For instance, as illustrated in FIG. 1c, the barrier rib 112 includes a first barrier rib 112b and a second barrier rib 112a. The barrier rib 112 may have a differential type barrier rib structure in which the height of the first barrier rib 112b and the height of the second barrier rib 112a are different from each other, a channel type barrier rib structure in which a channel usable as an exhaust path is formed on at least one of the first barrier rib 112b or the second barrier rib 112a, a hollow type barrier rib structure in which a hollow is formed on at least one of the first barrier rib 112b or the second barrier rib 112a, and the like.

In the differential type barrier rib structure, as illustrated in FIG. 1c, a height hi of the first barrier rib 112b may be less than a height h2 of the second barrier rib 112a. Further, in the channel type barrier rib structure or the hollow type barrier rib structure, a channel or a hollow may be formed on the first barrier rib 112b.

While the plasma display panel according to one embodiment has been illustrated and described to have the red (R), green (G), and blue (B) discharge cells arranged on the same line, it is possible to arrange them in a different pattern. For instance, a delta type arrangement in which the red (R), green (G), and blue (B) discharge cells are arranged in a triangle shape may be applicable. Further, the discharge cells may have a variety of polygonal shapes such as pentagonal and hexagonal shapes as well as a rectangular shape.

A predetermined discharge gas is filled in the discharge cells partitioned by the barrier ribs 112.

Phosphor layers 114 for emitting visible light for an image display when generating an address discharge are formed inside the discharge cells partitioned by the barrier ribs 112. For instance, red (R), green (G) and blue (B) phosphor layers may be formed inside the discharge cells.

A white (W) phosphor layer and/or a yellow (Y) phosphor layer may be further formed in addition to the red (R), green (G) and blue (B) phosphor layers.

The thicknesses (widths) of the phosphor layers 114 formed inside the red (R), green (G) and blue (B) discharge cells may be substantially equal to one another, or the thickness of at least one of them may be different from the thickness of the others. For instance, when the thickness of the phosphor layer 114 in at least one of the red (R), green (G) and blue (B) discharge cells is different from the thickness of the other discharge cells, thicknesses t2 and t3 of the phosphor layers 114 in the green (G) and blue (B) discharge cells, as illustrated in FIG. 1d, is more than a thickness t1 of the phosphor layer 114 in the red (R) discharge cell. The thickness t2 of the phosphor layer 114 in the green (G) discharge cell may be substantially equal to or different from the thickness t3 of the phosphor layer 114 in the blue (B) discharge cell.

It should be noted that only one example of the plasma display panel according to one embodiment has been illustrated and described above, and the embodiment is not limited to the plasma display panel of the above-described structure. For instance, although the above description illustrates a case where the upper dielectric layer 104 and the lower dielectric layer 115 each are formed in the form of a single layer, at least one of the upper dielectric layer 104 and the lower dielectric layer 115 may be formed in the form of a plurality of layers.

A black layer (not shown) for absorbing external light may be further formed on the upper portion of the barrier ribs 112 to prevent the reflection of the external light caused by the barrier ribs 112.

Further, a black layer (not shown) may be further formed at a predetermined position on the front substrate 101 corresponding to the barrier ribs 112.

The third electrode 113 formed on the rear substrate 11 may have a substantially constant width or thickness. Further, the width or thickness of the third electrode 113 inside the discharge cell may be different from the width or thickness of the third electrode 113 outside the discharge cell. For instance, the width or thickness of the third electrode 113 inside the discharge cell may be more than the width or thickness of the third electrode 113 outside the discharge cell.

In this way, the structure of the plasma display panel according to one embodiment may be changed in various ways.

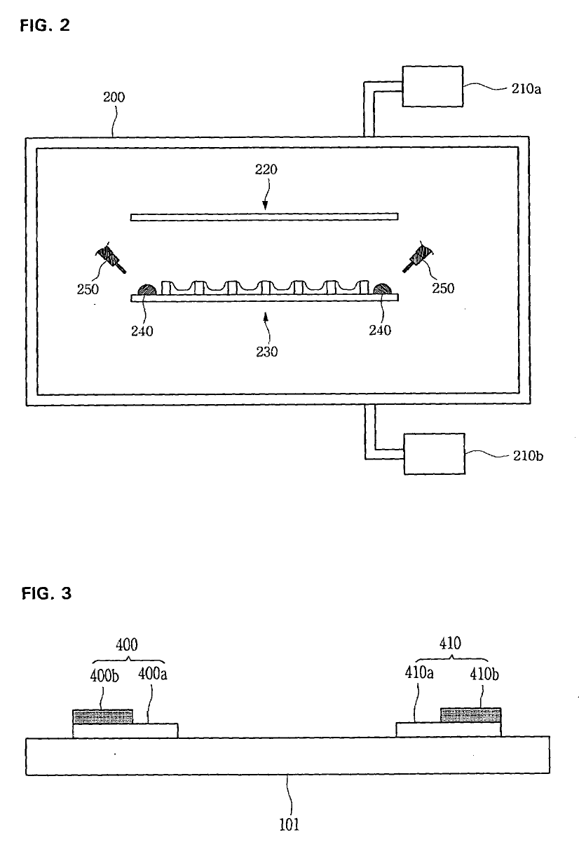

FIG. 2 illustrates an example of a method of manufacturing the plasma display panel according to one embodiment in which an exhaust hole is omitted.

Referring to FIG. 2, a reference numeral 200 indicates a chamber in which a front substrate 220 and a rear substrate 230 are disposed. A reference numeral 210a indicates an exhaust portion for exhausting a gas filled in the chamber 200. A reference numeral 210b indicates a gas injection unit for injecting a discharge gas in the chamber 200. A reference numeral 250 indicates a firing unit for firing a seal layer 240.

First, the front substrate 220 and the rear substrate 230 formed through predetermined processes are disposed in the chamber 200.

The seal layer 240 for coalescing the front substrate 220 and the rear substrate 230 may be formed on a portion of at least one of the front substrate 220 or the rear substrate 230. For example, as illustrated in FIG. 2, the seal layer 240 may be formed on the rear substrate 230.

The exhaust portion 210a exhausts a gas filled in the chamber 200 in which the front substrate 220 and the rear substrate 230 are disposed. In other words, the exhaust portion 210a exhausts an impure gas inside the chamber 200 to the outside.

Next, the gas injection unit 210b injects a discharge gas inside the chamber 200. More specifically, a discharge gas such as xenon (Xe), neon (Ne), argon (Ar) is injected into the chamber 200 so that a pressure of the chamber 200 ranges from about 4×10⁻² torr to about 2 torr in an atmosphere of a temperature of about 200-400°0 C.

The front substrate 220 and the rear substrate 230 are coalesced using a predetermined coalescing device (not illustrated). The firing unit 250 applies heat or light to the seal layer 240 such that the seal layer 240 is hardened. As a result, the front substrate 220 and the rear substrate 230 are coalesced sufficiently strongly.

The seal layer 240 may include a photo-crosslinked material. The firing unit 250 applies light to the seal layer 240 when coalescing the front substrate 220 and the rear substrate 230, thereby curing and firing the seal layer 240. Thus, the above process prevents the generation of an impure gas when firing the seal layer 240.

As above, since the plasma display panel is completed through the coalescing of the front substrate 220 and the rear substrate 230, the process for coalescing the front substrate 220 and the rear substrate 230 and the process for injecting the discharge gas are performed together. Thus, the front substrate 220 and the rear substrate 230 do not need to have an exhaust unit, i.e., an exhaust hole. In other words, the exhaust hole may be omitted.

As above, an exhaust tip for connecting the gas injection unit for injecting the discharge gas through the exhaust hole to the front and rear substrates 220 and 230 may be omitted. The exhaust tip may be interpreted as an exhaust pipe.

In a case where an impure gas inside the plasma display panel is exhausted and a discharge gas is injected into the plasma display panel using an exhaust unit in accordance with the related art, the exhaust unit is disposed at a specific position of the plasma display panel. Further, since after coalescing front and rear substrates, the exhaust of the impure gas and the gas injection are performed, there is a great likelihood that the impure gas remains inside the plasma display panel (i.e., inside discharge cells). Thus, in the structure of the related art plasma display panel including the exhaust unit, the impure gas interferes in the discharge such that a firing voltage further increases and the discharge is stably performed due to the deviation of the exhaust. As a result, the driving efficiency decreases.

On the other hand, as illustrated in FIG. 2, when the coalescence process of the front and rear substrates 220 and 230 and the injection process of the discharge gas are performed together, the impure gas is removed sufficiently and the discharge gas is injected sufficiently uniformly.

As compared the structure of the plasma display panel of FIG. 2, in which the exhaust unit is omitted, with the structure of the related art plasma display panel including the exhaust unit, the plasma display panel of FIG. 2 generates a sufficiently stable discharge under a relatively low firing voltage (i.e., a driving voltage).

In the structure of the related art plasma display panel including the exhaust unit, a formation process of the exhaust hole, a coalescence process, a coupling process of an exhaust tip, an exhaust process, a gas injection process, and the like, are included sequentially.

On the other hand, in the structure of the plasma display panel of FIG. 2, in which the exhaust unit is omitted, since the exhaust process and the gas injection process when performing the coalescence process are performed together, the number of manufacturing processes and manufacturing time are reduced. Thus, the manufacturing cost is reduced.

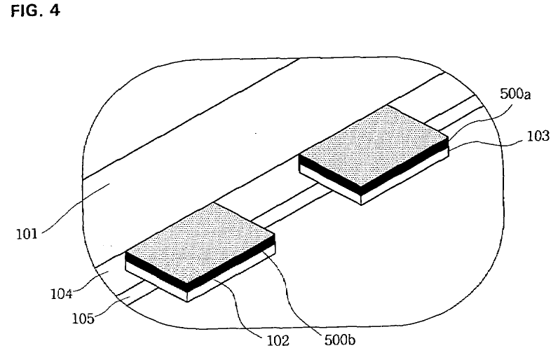

FIG. 3 illustrates a reason why a first electrode and a second electrode have a single layer structure in the structure of the plasma display panel in which an exhaust unit is omitted.

Unlike the structure of the plasma display panel according to one embodiment, referring to FIG. 3, a first electrode 400 and a second electrode 410 formed on the front substrate 101 are formed in the form of a plurality of layers.

More specifically, the first electrode 400 and the second electrode 410 each include transparent electrodes 400a and 410a and bus electrodes 400b and 410b.

In FIG. 3, the transparent electrodes 400a and 410a are formed, and the bus electrodes 400b and 410b are then formed.

As compared with the single layer structure of the first and second electrodes, the number of manufacturing processes in the first and second electrodes 400 and 410 of FIG. 3 increases such that the manufacturing cost increases.

Further, since the first electrode 400 and the second electrode 410 of FIG. 3 use relatively expensive ITO, the manufacturing cost further increases.

On the other hand, since the first and second electrodes have the single layer structure in the plasma display panel according to one embodiment, the manufacturing process is simple. Further, the first and second electrodes are manufactured without using a relatively expensive material such as ITO.

Since the first and second electrodes having the single layer structure do not use a transparent material, the first and second electrodes may have a color darker than the upper dielectric layer formed on the front substrate such that an aperture ratio may be reduced. When the widths of the first and second electrodes are reduced so as to raise the aperture ratio, the firing voltage rises such that the driving efficiency is reduced.

However, in the plasma display panel according to one embodiment not having the exhaust unit, as described above, the discharge gas is injected uniformly such that the firing voltage may be low. Even if the first and second electrodes have the single layer structure and the widths of the first and second electrodes decrease, a sharp increase in the firing voltage is prevented. As a result, a reduction in the aperture ratio and the driving efficiency is prevented in addition to a reduction in the manufacturing cost.

The first and second electrodes having the single layer structure may include an electrically conductive opaque metal material. For instance, an inexpensive material having the excellent electrical conductivity, for example, silver (Ag), copper (Cu), aluminum (Al) may be used.

FIG. 4 illustrates an example of a structure in which a black layer is formed between first and second electrodes and a front substrate.

Referring to FIG. 4, black layers 500a and 500b are formed between the front substrate 101 and the first and second electrodes 102 and 103. The black layers 500a and 500b prevent discoloration of the front substrate 101, and have a color darker than at least one of the first or second electrode 102 or 103. In other words, when the front substrate 101 directly contacts the first or second electrode 102 or 103, a predetermined area of the front substrate 101 directly contacting the first or second electrode 102 or 103 may change to yellow. The change of color is called a migration phenomenon. The black layers 500a and 500b prevent the migration phenomenon, thereby preventing the discoloration of the front substrate 101.

The black layers 500a and 500b may include a black material having a substantially dark color, for example, ruthenium (Ru).

Since the black layers 500a and 500b are formed between the front substrate 101 and the first and second electrodes 102 and 103, the generation of reflection light is prevented even if the first and second electrodes 102 and 103 are made of a material of a high reflectivity.

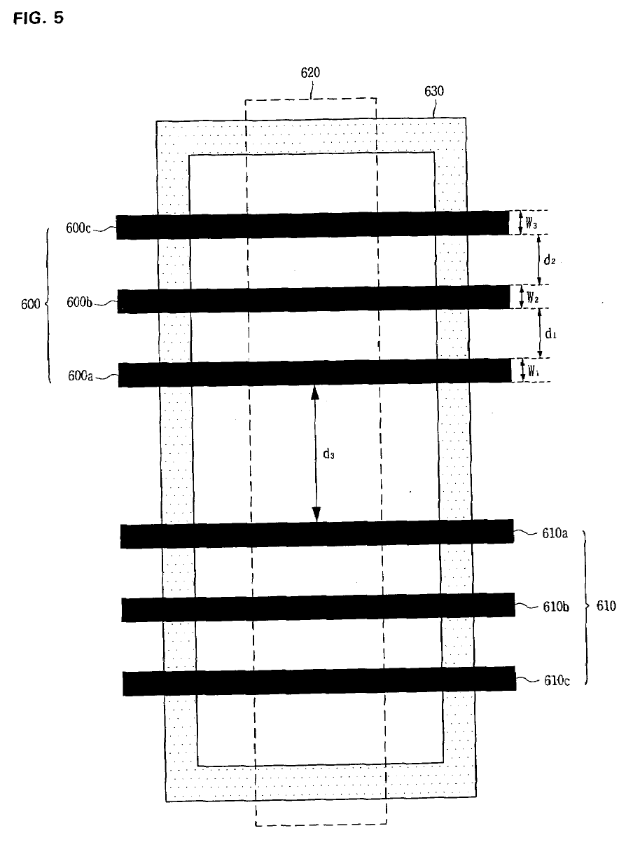

FIG. 5 illustrates a first example associated with a first electrode and a second electrode in the plasma display panel according to one embodiment.

Referring to FIG. 5, at least one of a first electrode 600 and a second electrode 610 includes a plurality of line portions 600a, 600b, 600c, 610a, 610b and 610c.

The line portions 600a, 600b, 600c, 610a, 610b and 610c are formed to intersect a third electrode 620 within a discharge cell partitioned by a barrier rib 630.

The line portions 600a, 600b, 600c, 610a, 610b and 610c are spaced from one another at a predetermined distance.

For example, the first and second line portions 600a and 600b of the first electrode 600 are spaced with a distance d1, and the second and third line portions 600b and 600c of the first electrode 600 are spaced with a distance d2. The distances d1 and d2 may be equal to or different from each other.

Two or more line portions may be adjacent to each other.

The line portions 600a, 600b, 600c, 610a, 610b and 610c each have a predetermined width.

For example, the first, second, third line portions 600a, 600b and 600c of the first electrode 600 have widths W1, W2 and W3, respectively. The widths W1, W2 and W3 may be equal to one another.

The shape of the first electrode 600 is symmetrical to the shape of the second electrode 610 within the discharge cell.

A discharge may occur between the first line portion 600a of the first electrode 600 and the first line portion 610a of the second electrode 610 which are spaced with a distance d3. The above discharge may diffused between the second line portion 600b of the first electrode 600 and the second line portion 610b of the second electrode 610, and between the third line portion 600c of the first electrode 600 and the third line portion 610c of the second electrode 610.

Although the above description has been made with respect to a case where the shape of the first electrode 600 is symmetrical to the shape of the second electrode 610, the shape of the first electrode 600 may be asymmetrical to the shape of the second electrode 610.

For example, while the first electrode 600 may include three line portions, the second electrode 610 may include two line portions.

Furthermore, it is possible to control the number of line portions. For example, the first electrode 600 or the second electrode 610 may include 4 or 5 line portions.

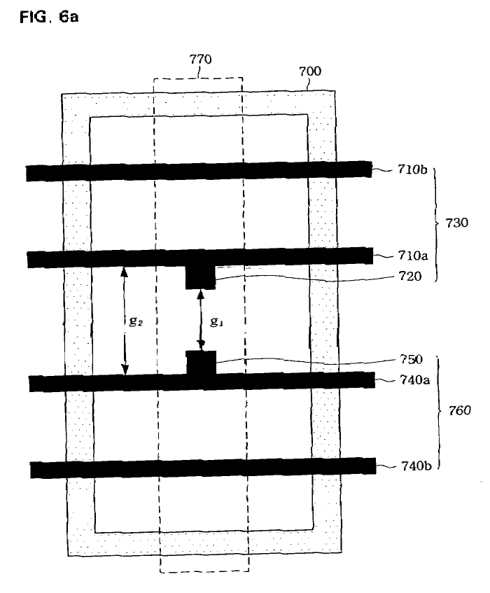

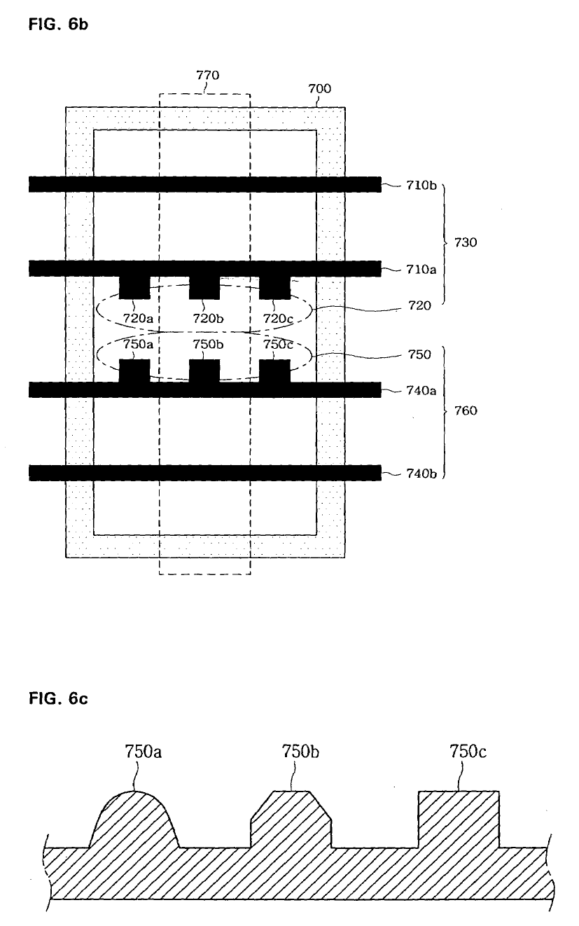

FIGS. 6a to 6c illustrate a second example associated with a first electrode and a second electrode in the plasma display panel according to one embodiment. The description about structures and components identical or equivalent to those illustrated and described in the first example is omitted from the description about structures and components illustrated in FIGS. 6a to 6c.

Referring to FIG. 6a, at least one of a first electrode 730 and a second electrode 760 includes a plurality of line portions 710a, 710b, 740a, 740b intersecting a third electrode 770, and projecting portions 720 and 750 in parallel to the third electrode 770.

The projecting portions 720 and 750 project from the one or more line portions 710a, 710b, 740a, 740b. For example, the projecting portion 720 of the first electrode 730 projects from the line portions 710a, and the projecting portion 750 of the second electrode 760 projects from the line portions 740a.

A distance g1 between the first electrode 730 and the second electrode 760 in a formation portion of the projecting portions 720 and 750 is shorter than a distance g2 between the first electrode 730 and the second electrode 760 in a portion except the formation portion of the projecting portions 720 and 750 inside a discharge cell partitioned by a barrier rib 700. Thus, a firing voltage of a discharge generated between the first electrode 730 and the second electrode 760 is lowered.

The projecting portions 720 and 750 may overlap the third electrode 770 inside the discharge cell. The above-described formation of the projecting portions 720 and 750 lowers a firing voltage between the first electrode 730 and the third electrode 770, and a firing voltage between the second electrode 760 and the third electrode 770.

Referring to FIG. 6b, the first electrode 730 and the second electrode 760 each include a plurality of projecting portions 720a, 720b, 720c, 750a, 750b and 750c. More specifically, the first electrode 730 includes the first, second and third projecting portions 720a, 720b and 720c. The second electrode 760 includes the first, second and third projecting portions 750a, 750b and 750c.

As illustrated in FIGS. 6a and 6b, it is possible to control the number of projecting portions.

Referring to FIG. 6c, the projecting portions 750a, 750b and 750c may be formed in various shapes.

More specifically, the projecting portion 750a is formed in the shape with curvature. The projecting portions 750b and 750c are formed in a polygonal shape.

When the plurality of projecting portions are formed, the shape of at least one of the plurality of projecting portions may be different from the shapes of the other projecting portions. For example, when the two projecting portions are formed, one may include a portion having curvature shaped like the projecting portion 750a of FIG. 6c, and the other may have a rectangular shape like the projecting portion 750c of FIG. 6c.

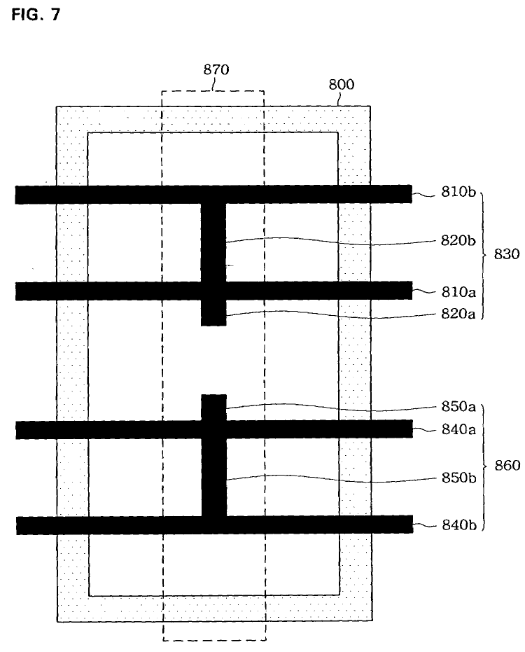

FIG. 7 illustrates a third example associated with a first electrode and a second electrode in the plasma display panel according to one embodiment. The description about structures and components identical or equivalent to those illustrated and described in the first and second examples is omitted from the description about structures and components illustrated in FIG. 7.

Referring to FIG. 7, connection portions 820b and 850b connecting two or more line portions of a plurality of line portions 810a, 810b, 840a and 840b are formed.

The connection portion 820b of the first electrode 830 connects first and second line portions 810a and 810b of the first electrode 830. The connection portion 850b of the second electrode 860 connects first and second line portions 840a and 840b of the second electrode 860.

The connection portions 820b and 850b connecting the two line portions make it easy to diffuse a discharge generated inside a discharge cell partitioned by a barrier rib 800.

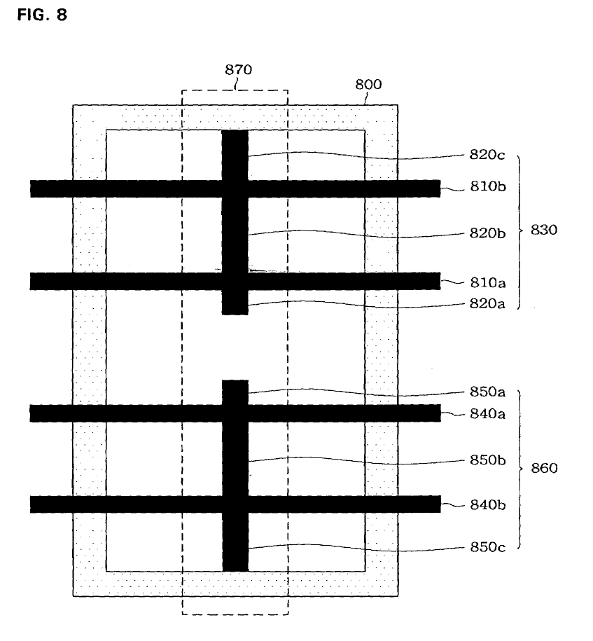

FIG. 8 illustrates a fourth example associated with a first electrode and a second electrode in the plasma display panel according to one embodiment. The description about structures and components identical or equivalent to those illustrated and described the first to third examples is omitted from the description about structures and components illustrated in FIG. 8.

Referring to FIG. 8, at least one of a plurality of projecting portions 820a, 820c, 850a and 850c projects from at least one of a plurality of line portions 810a, 810b, 840a and 840b in a first direction. At least one of the remaining projecting portions projects from at least one of the plurality of line portions 810a, 810b, 840a and 840b in a second direction different from the first direction.

The first direction may be opposite to the second direction.

More specifically, the projecting portion 820a projects from the line portion 810a in the center of the discharge cell. The projecting portion 820c projects from the line portion 810b in a direction opposite to a projecting direction of the projecting portion 820a.

The projecting portions 820c and 850c diffuse a discharge generated inside the discharge cell more widely.

Although FIG, 8 has illustrated a case where the first and second electrodes 830 and 860 each include the projecting portions 820a and 850a projecting in the center of the discharge cell, the first and second electrodes 830 and 860 each may include one or more projecting portions projecting in the center of the discharge cell. The projecting portions 820a and 850a projecting in the center of the discharge cell lower the firing voltage, and efficiently diffuse the discharge.

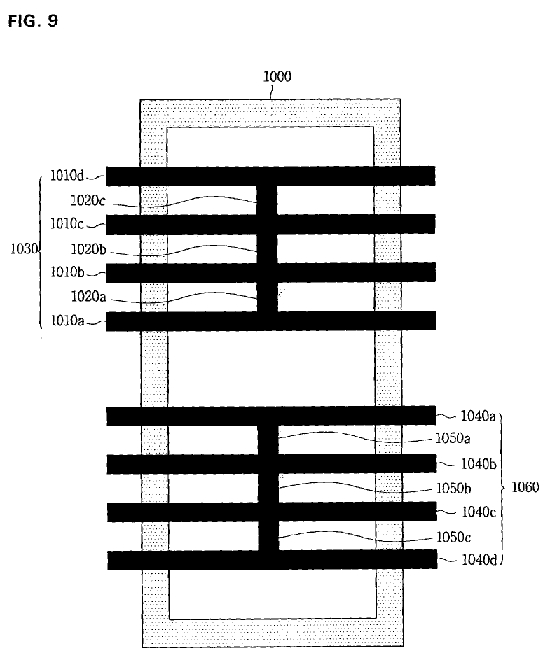

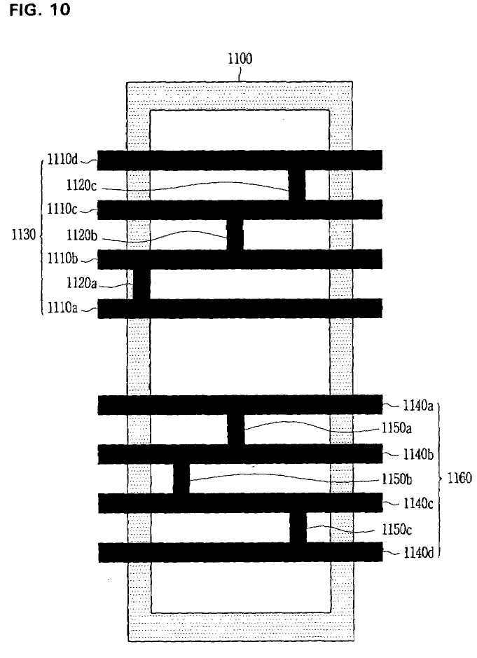

FIG. 9 illustrates a fifth example associated with a first electrode and a second electrode in the plasma display panel according to one embodiment. The description about structures and components identical or equivalent to those illustrated and described in the first to fourth examples is omitted from the description about structures and components illustrated in FIG. 9.

Referring to FIG. 9, a first electrode 1030 includes four line portions 1010a, 1010b, 1010c and 1010d, and three connection portions 1020a, 1020b and 1020c. A second electrode 1060 includes four line portions 1040a, 1040b, 1040c and 1040d, and three connection portions 1050a, 1050b and 1050c.

The connection portions each connect two or more line portions.

More specifically, in a case of the first electrode 1030, the first connection portion 1020a connects the first and second line portions 1010a and 1010b, the second connection portion 1020b connects the second and third line portions 1010b and 1010c, and the third connection portion 1020c connects the third and fourth line portions 1010c and 1010d.

FIG. 10 illustrates a sixth example associated with a first electrode and a second electrode in the plasma display panel according to one embodiment. The description about structures and components identical or equivalent to those illustrated and described in the first to fifth examples is omitted from the description about structures and components illustrated in FIG. 10.

Referring to FIG. 10, a first electrode 1130 includes four line portions 1110a, 1110b, 1110c and 1110d, and three connection portions 1120a, 1120b and 1120c. A second electrode 1160 includes four line portions 1140a, 1140b, 1140c and 1140d, and three connection portions 1150a, 1150b and 1150c. At least one of the three connection portions of each of the first and second electrodes 1130 and 1160 is different from the other connection portions in a formation location.

For example, as illustrated in FIG. 10, formation locations of the first and second connection portions 1120a and 1120b in the first electrode 1130 are different from each other. Further, formation locations of the second and third connection portions 1120b and 1120c in the first electrode 1130 are different from each other.

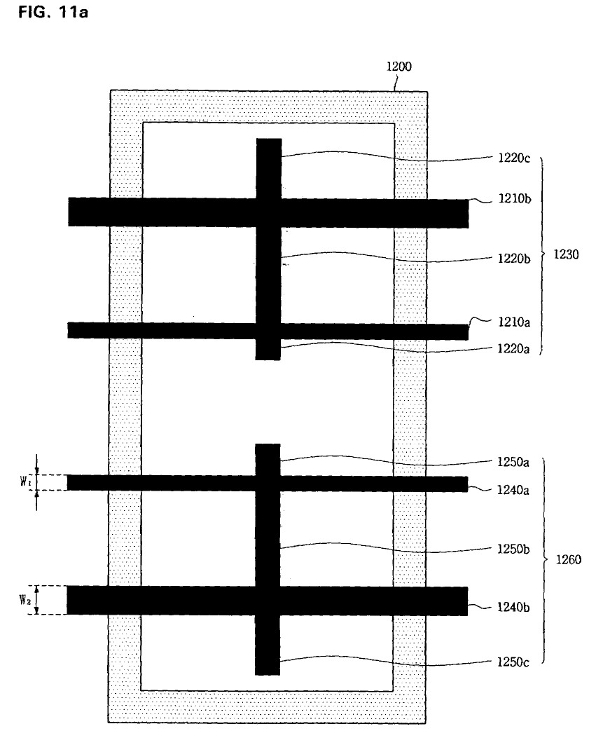

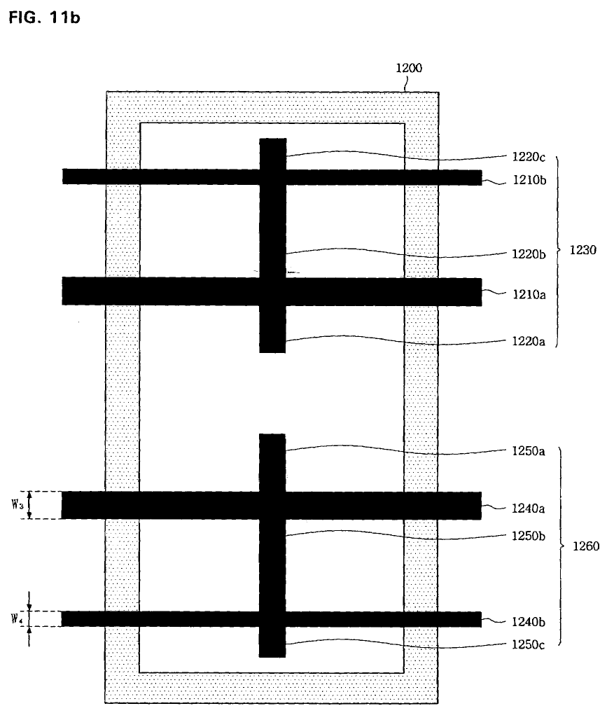

FIGS. 11a and 11b illustrate a seventh example associated with a first electrode and a second electrode in the plasma display panel according to one embodiment. The description about structures and components identical or equivalent to those illustrated and described in the first to sixth examples is omitted from the description about structures and components illustrated in FIGS. 11a and 11b.

Referring to FIG. 11a, the shape of at least one of a plurality of line portions of each of first and second electrodes 1230 and 1260 is different from the shape of the other line portions.

For example, when the width of a first line portion 1240a of the second electrode 1260 is equal to W1, the width of a second line portion 1240b may be equal to W2 more than W1.

On the contrary, referring to FIG. 11b, when the width of the first line portion 1240a of the second electrode 1260 is equal to W3, the width of the second line portion 1240b may be equal to W4 less than W4.

As above, it is possible to control the width of the line portions.

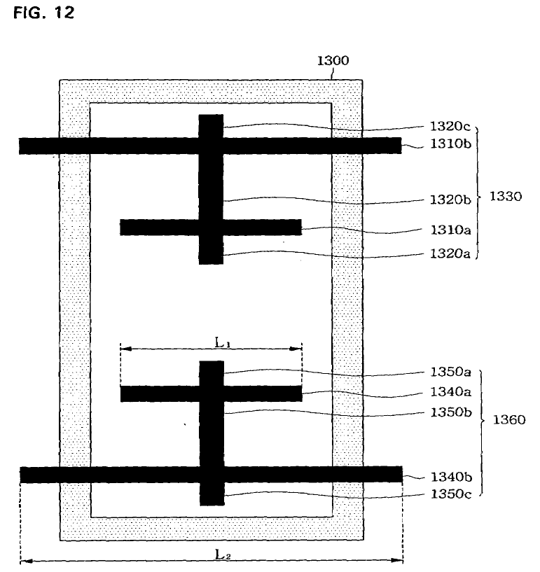

FIG. 12 illustrates an eighth example associated with a first electrode and a second electrode in the plasma display panel according to one embodiment. The description about structures and components identical or equivalent to those illustrated and described in the first to seventh examples is omitted from the description about structures and components illustrated in FIG. 12.

Referring to FIG. 12, the shape of at least one of a plurality of line portions of each of first and second electrodes 1330 and 1360 is different from the shape of the other line portions.

For example, when the length of a first line portion 1340a of the second electrode 1360 is equal to L1, the width of a second line portion 1340b may be equal to L2 shorter than L1.

Further, the length L1 may be longer than the length L2.

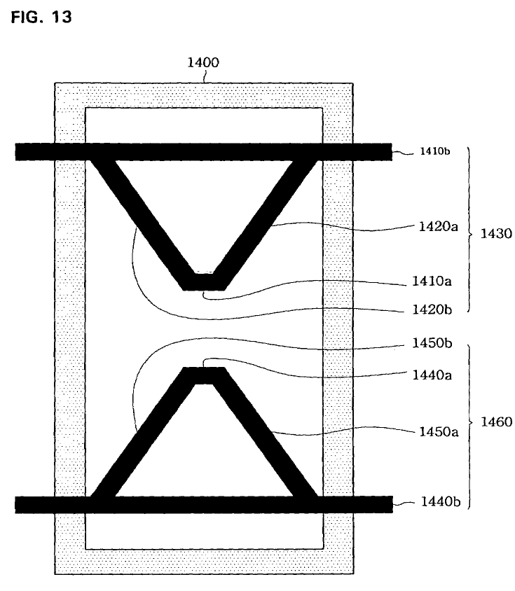

FIG. 13 illustrates a ninth example associated with a first electrode and a second electrode in the plasma display panel according to one embodiment. The description about structures and components identical or equivalent to those illustrated and described in the first to eighth examples is omitted from the description about structures and components illustrated in FIG. 13.

Referring to FIG. 13, first and second electrodes 1430 and 1460 each include first line portions 1410a and 1440a, and second line portions 1410b and 1440b having the length longer than the first line portions 1410a and 1440a.

Further, the first and second electrodes 1430 and 1460 each include first connection portions 1420a and 1450a, and second connection portions 1420b and 1450b. The first and second connection portions 1420a and 1420b of the first electrode 1430 project at an angle to the first line portions 1410a such that the first and second line portions 1410a and 1410b are connected to each other. The first and second connection portions 1450a and 1450b of the second electrode 1460 project at an angle to the first line portions 1450a such that the first and second line portions 1440a and 1440b are connected to each other.

Thus, the first and second electrodes 1430 and 1460 have a trapezoid shape.

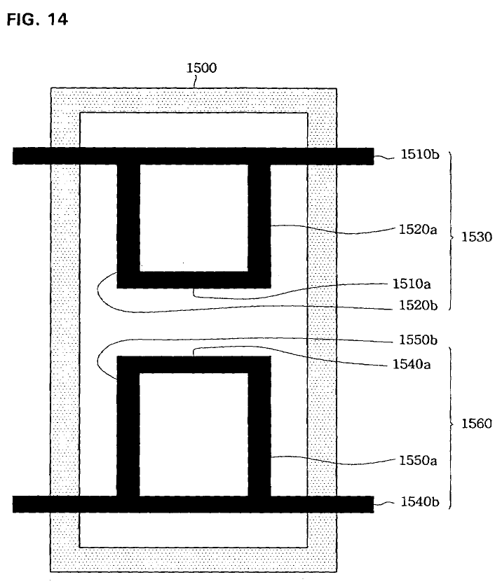

FIG. 14 illustrates a tenth example associated with a first electrode and a second electrode in the plasma display panel according to one embodiment. The description about structures and components identical or equivalent to those illustrated and described in the first to ninth examples is omitted from the description about structures and components illustrated in FIG. 14.

Referring to FIG. 14, first and second electrodes 1530 and 1560 have a rectangular shape.

As illustrated in FIGS. 13 and 14, the first and second electrodes in the plasma display panel according to one embodiment may have various polygonal shapes.

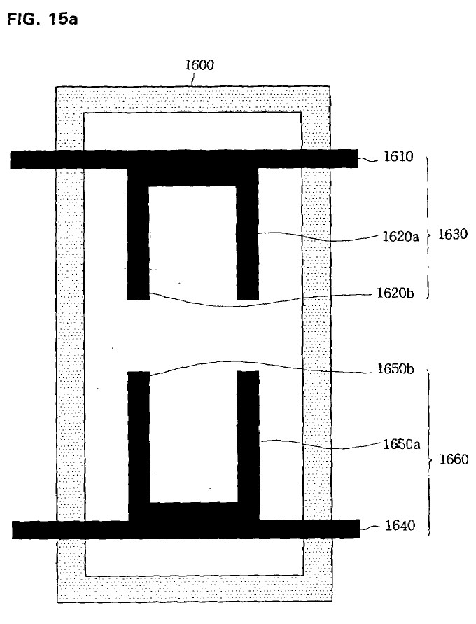

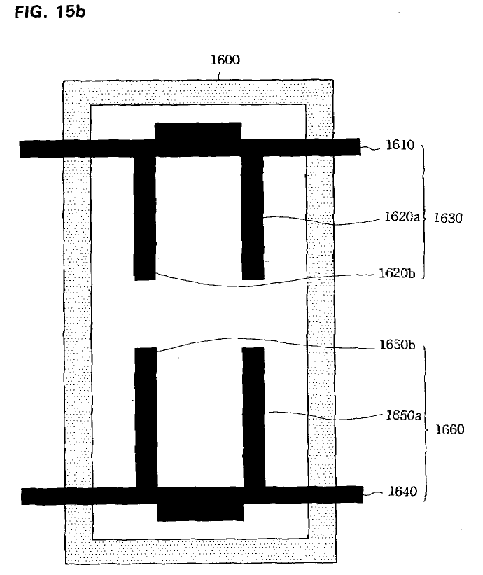

FIGS. 15a and 15b illustrate an eleventh example associated with a first electrode and a second electrode in the plasma display panel according to one embodiment. The description about structures and components identical or equivalent to those illustrated and described in the first to tenth examples is omitted from the description about structures and components illustrated in FIGS. 15a and 15b.

Referring to FIG. 15a, a line portion 1610 of a first electrode 1630 includes a middle projecting portion projecting from a middle portion of the line portion 1610 in the center of a discharge cell partitioned by a barrier rib 1600. Further, a line portion 1640 of a second electrode 1660 includes a middle projecting portion projecting from a middle portion of the line portion 1640 in the center of the discharge cell.

Projecting portions 1620a, 16020b, 1650a and 1650b project from the middle projecting portions.

Referring to FIG. 15b, the line portions 1610 and 1640 of the first and second electrodes 1630 and 1660 each include middle projecting portions projecting from the middle portions of the line portions 1610 and 1640 in a direction of opposite to a projecting direction of the middle projecting portions of FIG. 15a.

The projecting portions 1620a, 16020b, 1650a and 1650b of FIG. 15b project in the center of the discharge cell.

The above-described plasma display panel according to one embodiment may contain lead (Pb) equal to or less than 1,000 PPM (parts per million).

In other words, since the Pb content, based on total weight for all components of the plasma display panel according to one embodiment is equal to or less than 1,000 PPM, the total Pb content in the plasma display panel is equal to or less than 1,000 PPM.

Further, a Pb content in a specific component of the plasma display panel may be equal to or less than 1,000 PPM. For example, a Pb content in at least one of the barrier rib or the dielectric layer may be equal to or less than 1,000 PPM.

A Pb content in each component of the plasma display panel may be equal to or less than 1,000 PPM. In other words, a Pb content in each of the barrier rib, the dielectric layer, the electrode, the phosphor layer and the seal layer may be equal to or less than 1,000 PPM.

Sine the total Pb content in the plasma display panel is equal to or less than 1,000 PPM, Pb contained in the plasma display panel does not adversely affect to the human body.

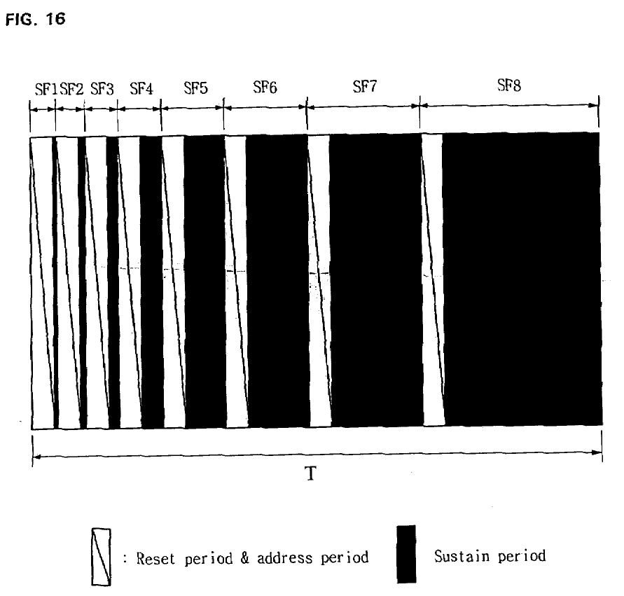

FIG. 16 illustrates a frame for achieving a gray level of an image displayed on the plasma display panel according to one embodiment.

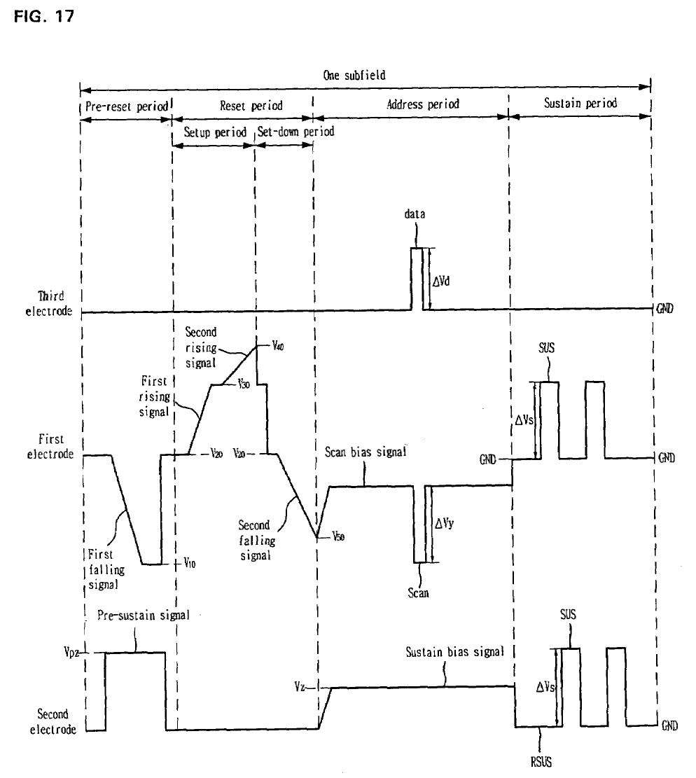

FIG. 17 illustrates an example of an operation of the plasma display panel according to one embodiment.

Referring to FIG. 16, in the plasma display panel according to one embodiment, a frame is divided into several subfields having a different number of emission times.

Each subfield is subdivided into a reset period for initializing all the cells, an address period for selecting cells to be discharged, and a sustain period for representing gray level in accordance with the number of discharges.

For example, if an image with 256-level gray level is to be displayed, a frame, as illustrated in FIG. 16, is divided into 8 subfields SF1 to SF8. Each of the 8 subfields SF1 to SF8 is subdivided into a reset period, an address period and a sustain period.

The number of sustain signals supplied during the sustain period determines gray level weight in each of the subfields. For example, in such a method of setting gray level weight of a first subfield to 2⁰ and gray level weight of a second subfield to 2¹, the sustain period increases in a ratio of 2ⁿ (where, n=0, 1, 2, 3, 4, 5, 6, 7) in each of the subfields. Since the sustain period varies from one subfield to the next subfield, a specific gray level is achieved by controlling the sustain period which are to be used for discharging each of the selected cells, i.e., the number of sustain discharges that are realized in each of the discharge cells.

The plasma display panel according to one embodiment uses a plurality of frames to display an image during 1 second. For example, 60 frames are used to display an image during 1 second. In this case, a duration T of time of one frame may be 1/60 seconds, i.e., 16.67 ms.

Although FIG. 16 has illustrated and described a case where one frame includes 8 subfields, the number of subfields constituting one frame may vary. For example, one frame may include 12 subfields SF1 to SF12 or 10 subfields SF1 to SF10.

Further, although FIG. 16 has illustrated and described the subfields arranged in increasing order of gray level weight, the subfields may be arranged in decreasing order of gray level weight, or the subfields may be arranged regardless of gray level weight.

FIG. 17 illustrates an example of an operation of the plasma display panel according to one embodiment in one subfield of a plurality of subfields of one frame as illustrated in FIG. 16.

During a pre-reset period prior to a reset period, a first falling signal is supplied to a first electrode Y.

During the supplying of the first falling signal to the first electrode Y, a pre-sustain signal of a polarity direction opposite a polarity direction of the first falling signal is supplied to a second electrode Z.

The first falling signal supplied to the first electrode Y gradually falls to a tenth voltage V10.

The pre-sustain signal is substantially maintained at a pre-sustain voltage Vpz. The pre-sustain voltage Vpz is substantially equal to a voltage (i.e., a sustain voltage Vs) of a sustain signal (SUS) which will be supplied during a sustain period.

As above, the first falling signal is supplied to the first electrode Y and the pre-sustain signal is supplied to the second electrode Z during the pre-reset period such that wall charges of a predetermined polarity are accumulated on the first electrode Y and wall charges of a polarity opposite the polarity of the wall charges accumulated on the first electrode Y are accumulated on the second electrode Z. For example, wall charges of a positive polarity are accumulated on the first electrode Y, and wall charges of a negative polarity are accumulated on the second electrode Z.

As a result, a setup discharge of a sufficient strength occurs during the reset period such that the initialization of all the discharge cells is performed stably.

Furthermore, although a voltage of a rising signal supplied to the first electrode Y during the reset period is low, a setup discharge of a sufficiently strength occurs.

A subfield, which is first arranged in time order in a plurality of subfields of one frame, may include a pre-reset period prior to a reset period so as to obtain sufficient driving time. Or, two or three subfields of the plurality of subfields may include a pre-reset period prior to a reset period.

Each subfield may not include the pre-reset period.

The reset period is further divided into a setup period and a set-down period. During the setup period, the rising signal of a polarity opposite a polarity of the first falling signal is supplied to the first electrode Y.

The rising signal includes a first rising signal and a second rising signal. The first rising signal gradually rises from a twentieth voltage V20 to a thirtieth voltage V30 with a first slope, and the second rising signal gradually rises from the thirtieth voltage V30 to a fortieth voltage V40 with a second slope.

The rising signal generates a weak dark discharge (i.e., a setup discharge) inside the discharge cell during the setup period, thereby accumulating a proper amount of wall charges inside the discharge cell.

The second slope of the second rising signal is gentler than the first slope of the first rising signal. When the second slope is gentler than the first slope, the voltage of the rising signal rises relatively rapidly until the setup discharge occurs, and the voltage of the rising signal rises relatively slowly during the generation of the setup discharge. As a result, the amount of light generated by the setup discharge is reduced. Accordingly, contrast of the plasma display panel is improved.

During the set-down period, a second falling signal of a polarity direction opposite a polarity direction of the rising signal is supplied to the first electrode Y. The second falling signal gradually falls from the twentieth voltage V20 to a fiftieth voltage V50. The second falling signal generates a weak erase discharge (i.e., a set-down discharge) inside the discharge cell. Furthermore, the remaining wall charges are uniform inside the discharge cells to the extent that an address discharge can be stably performed.

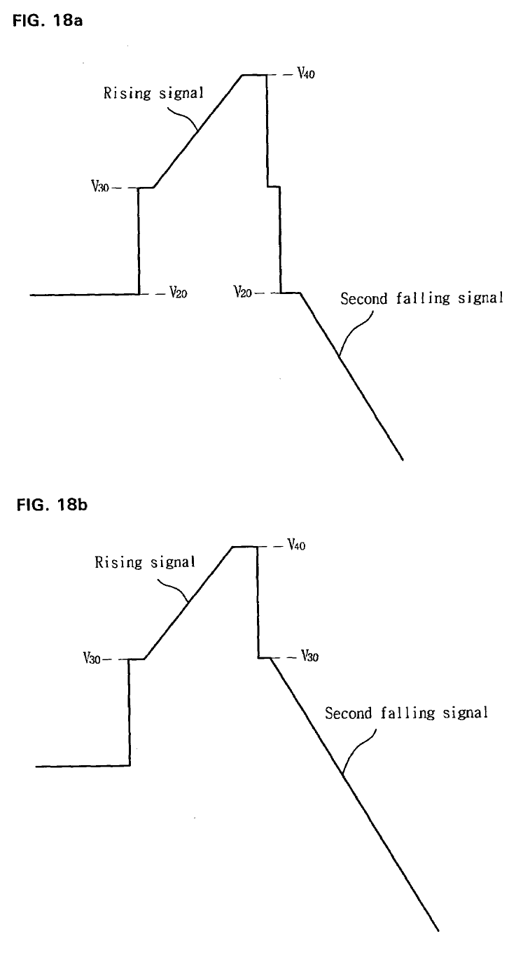

FIGS. 18a and 18b illustrate another form of a rising signal or a second falling signal.

Referring to FIG. 18a, the rising signal sharply rises to the thirtieth voltage V30, and then gradually rises from the thirtieth voltage V30 to the fortieth voltage V40.

The rising signal, as illustrated in FIG. 17, may gradually rise with the two different slopes through two stages. Further, the rising signal, as illustrated in FIG. 18a, may gradually rise through one stage. As above, the rising signal may vary in the various forms.

Referring to FIG. 18b, the second falling signal gradually falls from the thirtieth voltage V30. As above, a voltage falling time point of the second falling signal is changeable. In other words, the second falling signal may vary in the various forms.

Referring to FIG. 17, during the address period, a scan bias signal, which is substantially maintained at a voltage higher than the fiftieth voltage V50 of the second falling signal, is supplied to the first electrode Y.

A scan signal, which falls from the scan bias signal by a scan voltage magnitude ΔVy, is supplied to all the first electrodes Y1 to Yn.

For example, a first scan signal (Scan 1) is supplied to the first electrode Y1, and then a second scan signal (Scan 2) is supplied to the first electrode Y2. Therefore, an n-th scan signal (Scan n) is supplied to the first electrode Yn.

The width of the scan signal may vary from one subfield to the next subfield. In other words, the width of a scan signal in at least one subfield may be different from the width of a scan signal in another subfield. For example, the width of a scan signal in a subfield may be more than the width of a scan signal in the next subfield. Further, the width of the scan signal may be gradually reduced in the order of 2.6 μs, 2.3 μs, 2.1 μs, 1.9 μs, etc., or in the order of 2.6 μs, 2.3 μs, 2.3 μs, 2.1 μs, 1.9 μs, 1.9 μs, etc.

As above, when the scan signal (Scan) is supplied to the first electrode Y, a data signal (data) corresponding to the scan signal (Scan) is supplied to the third electrode X. The data signal (data) rises from a ground level voltage GND by a data voltage magnitude ΔVd.

As the voltage difference between the scan signal (Scan) and the data signal (data) is added to the wall voltage generated during the reset period, the address discharge is generated within the discharge cell to which the data signal (data) is supplied.

A sustain bias signal is supplied to the second electrode Z during the address period to prevent the generation of the unstable address discharge by interference of the second electrode Z. The sustain bias signal is substantially maintained at a sustain bias voltage Vz. The sustain bias voltage Vz is lower than the voltage of the sustain signal which will be supplied during the sustain period and is higher than the ground level voltage GND.

During the sustain period, a sustain signal (SUS) is alternately supplied to the first electrode Y and the second electrode Z. The sustain signal (SUS) has a voltage magnitude corresponding to a sustain voltage Vs.

As the wall voltage within the discharge cell selected by performing the address discharge is added to the sustain voltage Vs of the sustain signal (SUS), every time the sustain signal (SUS) is supplied, a sustain discharge, i.e., a display discharge occurs between the first electrode Y and the second electrode Z.

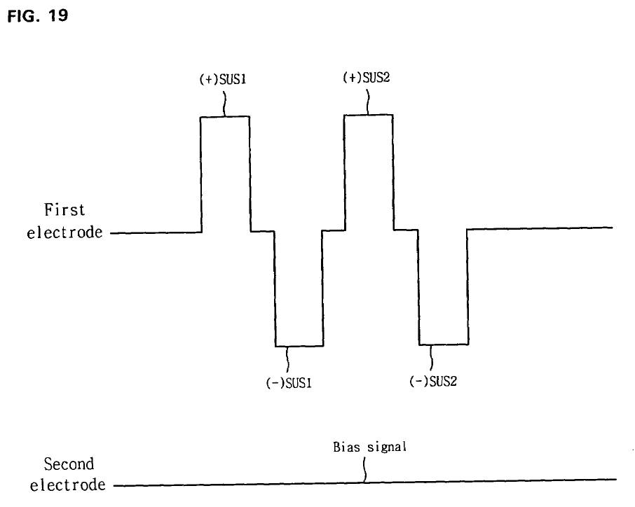

FIG. 19 illustrates another type of a sustain signal.

Referring to FIG. 19, a sustain signal of a positive polarity direction and a sustain signal of a negative polarity direction are alternately supplied to the first electrode Y or the second electrode Z, for example, to the first electrode Y.

As above, when the sustain signal of the positive polarity direction and the sustain signal of the negative polarity direction are alternately supplied to the first electrode Y, a bias signal is supplied to the second electrode Z. The bias signal is substantially maintained at the ground level voltage GND.

As illustrated in FIG. 19, when the sustain signal is supplied to either the first electrode Y or the second electrode Z, a single diving board for installing a circuit for supplying the sustain signal to either the first electrode Y or the second electrode Z is required. Accordingly, the whole size of a driver for driving the plasma display panel is reduced such that the manufacturing cost is reduced.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display panel, comprising:
a front substrate on which a first electrode and a second electrode are formed in parallel to each other;
a rear substrate on which a third electrode is formed to intersect the first electrode and the second electrode; and
a barrier rib formed between the front and rear substrates and partitioning a discharge cell,
wherein at least one of the first electrode or the second electrode is formed in the form of a single layer, and an exhaust unit is omitted in the rear substrate.

2. The plasma display panel of claim 1, wherein a seal layer coalescing the front substrate and the rear substrate is formed between the front substrate and rear substrate, and
the seal layer includes a photo-crosslinked material.

3. The plasma display panel of claim 1, further comprising a dielectric layer formed on the front substrate,
wherein at least one of the first electrode or the second electrode has a color darker than the dielectric layer.

4. The plasma display panel of claim 1, further comprising a black layer formed between the front substrate and at least one of the first electrode or the second electrode, wherein the black layer has a color darker than at least one of the first electrode or the second electrode.

5. The plasma display panel of claim 1, wherein at least one of the first electrode or the second electrode includes at least one line portion intersecting the third electrode, and at least one projecting portion projecting from at least one line portion in parallel to the third electrode.

6. The plasma display panel of claim 5, further comprising a connection portion connecting at least two line portions of the plurality of line portions.

7. The plasma display panel of claim 5, wherein the projecting portion includes a first projecting portion and a second projecting portion, and
the first projecting portion projects in a first direction, and the second projecting portion projects in a second direction different from the first direction.

8. The plasma display panel of claim 5, wherein the projecting portion includes a portion having curvature.

9. The plasma display panel of claim 1, wherein an exhaust unit is omitted in the front substrate.

10. The plasma display panel of claim 1, wherein the exhaust unit includes at least one of an exhaust hole, an exhaust tip, and an exhaust pipe.

11. The plasma display panel of claim 1, wherein the barrier rib includes a first barrier rib and a second barrier rib intersecting each other, and
the height of the first barrier rib is different from the height of the second barrier rib.

12. The plasma display panel of claim 1, wherein the discharge cell includes a first discharge cell and a second discharge cell,
a first phosphor layer is formed in the first discharge cell, and a second phosphor layer, that emits light of a color different from a color of light emitted from the first phosphor layer, is formed in the second discharge cell, and
the thickness of the first phosphor layer is different from the thickness of the second phosphor layer.

13. A plasma display panel, comprising:
a front substrate on which a first electrode and a second electrode are formed in parallel to each other;
a rear substrate on which a third electrode is formed to intersect the first electrode and the second electrode; and
a barrier rib formed between the front and rear substrates and partitioning a discharge cell,
wherein at least one of the first electrode or the second electrode is formed in the form of a single layer,
the rear substrate is a hole-less substrate, and
a lead (Pb) content is equal to or less than 1,000 ppm (parts per million).

14. The plasma display panel of claim 13, wherein the barrier rib includes a first barrier rib and a second barrier rib intersecting each other, and
the height of the first barrier rib is different from the height of the second barrier rib.

15. The plasma display panel of claim 13, wherein the discharge cell includes a first discharge cell and a second discharge cell,
a first phosphor layer is formed in the first discharge cell, and a second phosphor layer, that emits light of a color different from a color of light emitted from the first phosphor layer, is formed in the second discharge cell, and
the thickness of the first phosphor layer is different from the thickness of the second phosphor layer.

16. The plasma display panel of claim 13, wherein the front substrate is a hole-less substrate.

17. A plasma display panel, comprising:
a front substrate on which a first electrode and a second electrode are formed in parallel to each other;
a rear substrate on which a third electrode is formed to intersect the first electrode and the second electrode; and
a barrier rib formed between the front and rear substrates and partitioning a discharge cell,
wherein at least one of the first electrode or the second electrode is formed in the form of a single layer,
the rear substrate is a hole-less substrate,
the discharge cell includes a first discharge cell and a second discharge cell having a different pitch, and
a first phosphor layer is formed in the first discharge cell, and a second phosphor layer, that emits light of a color different from a color of light emitted from the first phosphor layer, is formed in the second discharge cell.

18. The plasma display panel of claim 17, wherein the thickness of the first phosphor layer is different from the thickness of the second phosphor layer.

19. The plasma display panel of claim 17, wherein the barrier rib includes a first barrier rib and a second barrier rib intersecting each other, and
the height of the first barrier rib is different from the height of the second barrier rib.

20. The plasma display panel of claim 17, wherein the front substrate is a hole-less substrate.
